(19) United States
(12) Patent Application Publication
(10) Pub. No.: US 2024/0340324 A1
(43) Pub. Date: Oct. 10, 2024

(54) Microphone Selection for Optimization of Audio Streams from Co-Located Devices

(71) Applicant: Google LLC, Mountain View, CA (US)

(72) Inventors: Manish Sonal, Stockholm (SE); Lionel Koenig Gélas, Mölnbo (SE); Jesús de Vicente Peña, Stockholm (SE); Esbjörn Dominique, Stockholm (SE)

(21) Appl. No.: 18/297,324

(22) Filed: Apr. 7, 2023

(51) Int. Cl. H04L 65/403; H04L 65/611; H04L 65/80

(52) U.S. Cl. CPC H04L 65/403; H04L 65/611; H04L 65/80

(57) ABSTRACT

Audio streams are received from participant computing devices of a participant cohort that includes a plurality of participant computing devices that are each located in a same area and are each connected to a teleconference. A first audio stream is selected from the two or more audio streams for broadcast based at least in part on signal quality information indicative of a signal quality associated with each of the two or more audio streams and/or historical signal quality information indicative of a signal quality associated with prior audio streams received from the two or more participant computing devices. The first audio stream is broadcasted to one or more participant computing devices different than the plurality of participant computing devices of the participant cohort.

### FIELD

The present disclosure relates generally to selecting microphones for audio streams from multiple co-located devices. More specifically, the present disclosure relates to determining which stream from a cohort of co-located devices is optimal for broadcast.

### BACKGROUND

Conventional teleconferencing services (e.g., videoconferencing, audioconferencing, multimedia conferencing, etc.) allow participants to participate using a variety of different computing devices. For example, laptop computers, desktop computers, smartphones, wearable devices (e.g., earbuds, smart watches, etc.), Augmented Reality (AR)/Virtual Reality (VR) devices, etc. can all be utilized by participants to participate in certain types of teleconferences. However, different types of computing devices often have access to audio capture devices of varying quality. For example, the quality of a microphone built into a laptop computer is often substantially higher than that of a wearable smartwatch device.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes receiving, by a teleconference computing system comprising one or more computing devices, two or more audio streams from two or more respective participant computing devices of a participant cohort, wherein the participant cohort comprises a plurality of participant computing devices that are each located in a same area and are each connected to a teleconference orchestrated by the teleconference computing system. The method includes selecting, by the teleconference computing system, a first audio stream from the two or more audio streams for broadcast based at least in part on at least one of signal quality information indicative of a signal quality associated with each of the two or more audio streams; or historical signal quality information indicative of a signal quality associated with prior audio streams received from the two or more participant computing devices. The method includes causing, by the teleconference computing system, broadcast of the first audio stream to one or more participant computing devices different than the plurality of participant computing devices of the participant cohort.

Another aspect of the present disclosure is directed to a teleconference computing system that includes one or more processors and one or more non-transitory computer-readable media that store instructions that, when executed by the one or more processors, cause the teleconference computing system to perform operations. The operations include receiving two or more audio streams from two or more respective participant computing devices of a participant cohort, wherein the participant cohort comprises a plurality of participant computing devices that are each located in a same area and are each connected to a teleconference orchestrated by the teleconference computing system. The operations include obtaining signal quality information indicative of a signal quality associated with each of the two or more audio streams. The operations include updating a signal histogram associated with the plurality of participant computing devices of the participant cohort, wherein a signal histogram is indicative of a historical signal quality indicative of a signal quality associated with prior audio streams received from participant computing devices. The operations include selecting a first audio stream from the two or more audio streams for broadcast based at least in part on the signal histogram. The operations include causing broadcast of the first audio stream to one or more participant computing devices different than the plurality of participant computing devices of the participant cohort.

Another aspect of the present disclosure is directed to one or more non-transitory computer-readable media that store instructions that, when executed by one or more processors, cause the one or more processors to perform operations. The operations include receiving two or more audio streams from two or more respective participant computing devices of a participant cohort, wherein the participant cohort comprises a plurality of participant computing devices that are each located in a same area and are each connected to a teleconference orchestrated by a teleconference computing system. The operations include selecting a first audio stream from the two or more audio streams for broadcast based at least in part on at least one of signal quality information indicative of a signal quality associated with each of the two or more audio streams, or historical signal quality information indicative of a signal quality associated with prior audio streams received from the two or more participant computing devices. The operations include causing broadcast of the first audio stream to one or more participant computing devices different than the plurality of participant computing devices of the participant cohort.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an overview data flow diagram for selecting an audio stream to represent a cohort of multiple co-located participant computing devices for a teleconference according to some implementations of the present disclosure.

FIG. 2 is a flow diagram of an example method for performing audio stream selection for representation of a cohort of multiple co-located participant computing devices for a teleconference, in accordance with some embodiments of the present disclosure.

FIG. 3A depicts a more detailed data flow diagram for selecting an audio stream to represent a cohort of multiple co-located participant computing devices for a teleconference at a first time T1 according to some implementations of the present disclosure

FIG. 3B depicts a more detailed data flow diagram for switching an audio stream that represents a cohort of multiple co-located participant computing devices for a teleconference at a second time T2 according to some implementations of the present disclosure

FIG. 3C depicts a data flow diagram for enhancing an audio stream that represents a cohort of multiple co-located participant computing devices for a teleconference at a second time T2 according to some implementations of the present disclosure

FIG. 4 is a block diagram for selecting an audio stream for broadcast based on signal quality information and historical signal quality information according to some implementations of the present disclosure.

FIG. 5 depicts a block diagram of an example computing environment that performs audio stream selection for representation of a cohort of co-located participant computing devices according to example implementations of the present disclosure.

Reference numerals that are repeated across plural figures are intended to identify the same features in various implementations.

### DETAILED DESCRIPTION

Generally, the present disclosure is directed to selecting an optimal stream for broadcast from among the streams of multiple co-located devices. More specifically, with the rising popularity of teleconferencing, it is increasingly common for co-located participants (e.g., participants located within the same room, etc.) to individually participate in the same teleconferencing session (e.g., three co-workers who each have a desk in the same room may individually participate in the same teleconference from their desks). However, modern audio capture devices (e.g., microphones) are usually sensitive enough to detect audio (e.g., spoken utterances, etc.) produced from anywhere within a relatively large space (e.g., a large room, etc.). As such, because one microphone is often sufficient to capture audio from multiple co-located participants, broadcasting audio streams from each co-located participant device (e.g., smartphone, laptop, etc.) is an inefficient use of network resources, and furthermore, is likely to cause echo for recipients.

Accordingly, implementations of the present disclosure propose the dynamic selection of a single audio stream (i.e., a microphone) to represent a cohort of multiple co-located devices. For example, three co-workers can each individually participate in a teleconference from the same room. One co-worker can utilize a smartphone device, while another can utilize a desktop computing device with a dedicated omni-directional microphone. Both devices can transmit audio streams to a computing system (e.g., a teleconference computing system) that orchestrates the teleconference. If the computing system determines that the stream captured using the omni-directional microphone is “higher quality” than the stream captured using the smartphone device, the computing system can select that stream for broadcast to represent all three co-located participants to other participants in the teleconference. In such fashion, the computing system can eliminate a substantial vector for echo while also reducing the expenditure of network resources and ensuring that the highest quality audio available is provided to participants of the teleconference.

Aspects of the present disclosure provide a number of technical effects and benefits. As one example technical effect and benefit, conventional teleconferencing services generally lack the capability to identify cohorts of co-located devices and to represent co-located devices using an audio stream from one audio capture device. As such, these conventional services will receive and broadcast redundant streams from multiple co-located participant computing devices, therefore degrading teleconference quality (e.g., due to echo) while wasting substantial quantities of network resources (e.g., power, bandwidth, compute cycles, battery, memory, etc.). Accordingly, implementations of the present disclosure propose selecting an audio stream captured by a single, specific audio capture device to represent a cohort of co-located devices. More specifically, by limiting broadcast to a single, highest-quality audio stream, implementations of the present disclosure substantially reduce the expenditure of network resources while eliminating a potential vector for teleconference quality degradation.

Throughout the present disclosure, the selection of an “audio stream” for broadcast may be interchangeably referred to as selection of a “microphone” or “audio capture device”, and vice-versa. More specifically, implementations of the present disclosure describe the selection of an audio stream for broadcast to other participant computing devices. However, the selection of a stream of audio captured at a specific audio capture device necessarily describes the selection of that specific audio capture device. As such, it should be broadly understood that the selection of a “microphone” or “audio capture device” is not necessarily distinct from the selection of an audio stream, and vice-versa.

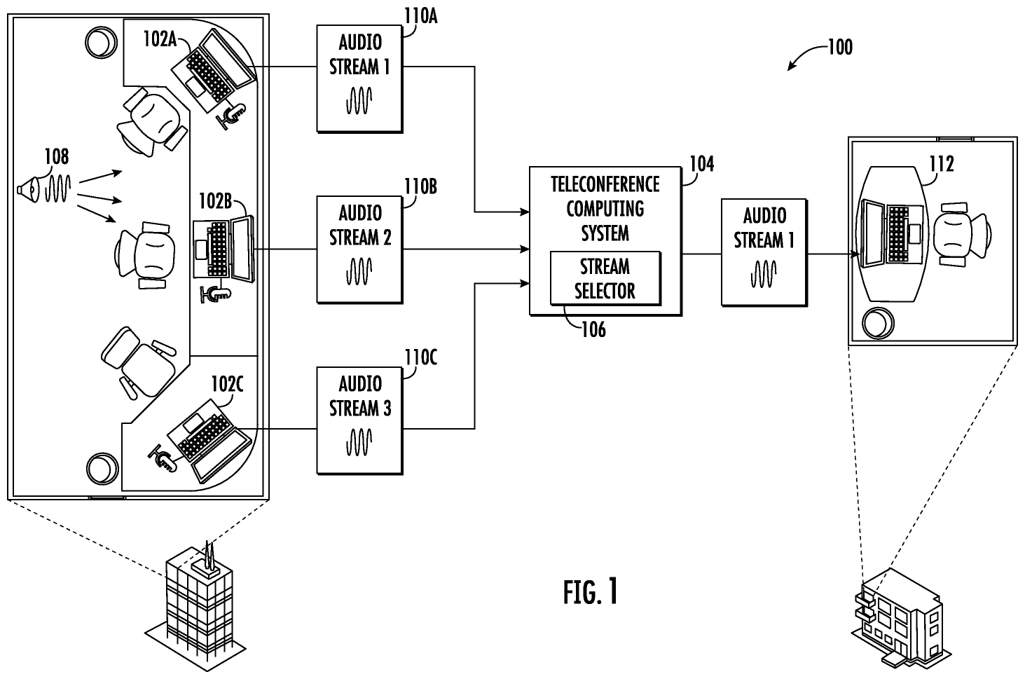

FIG. 1 depicts an overview data flow diagram 100 for selecting an audio stream to represent a cohort of multiple co-located participant computing devices for a teleconference according to some implementations of the present disclosure. More specifically, participant computing devices 102A, 102B, and 102C (generally, participant computing devices 102) can each be co-located within the same room (e.g., located within a certain distance of each other, etc.) while participating in a teleconference orchestrated by teleconference computing system 104. Due to the co-location of participant computing devices 102 (e.g., smartphones, laptops, earbuds, wearable devices, etc.), the teleconference computing system can collectively represent each of the devices as a participant cohort within the teleconference (rather than three individual entities). A “participant cohort” can be a grouping of closely located participant computing devices that are collectively represented as a single entity (e.g., avatar, “user”, etc.) within the teleconference. For example, if all of the devices of the participant cohort are located within the same room, the participant cohort may be represented as an entity labeled “room 1” within an interface of the teleconference.

Assume that an audio source 108 produces audio (e.g., a participant speaking, etc.) that is captured by the microphones associated with participant computing devices 102. The participant computing devices 102 can transmit audio streams 110A, 110B, and 110C (generally, audio streams 110) that include the captured audio. The teleconference computing system 104 can obtain information indicating a relative “quality” of the audio streams 110 (and/or the microphones used to capture the audio streams 110). Based on the relative quality of the audio streams 110, the teleconference computing system 104 can select the audio stream 110 with the greatest “quality” for broadcast to another participant computing device 112 that is not assigned to the participant cohort (e.g., is not co-located with the other devices).

To follow the depicted example, assume that participant computing device 102A is connected to a high-quality purpose-built microphone, and that participant computing device 102B has a built-in microphone of lower quality. Both microphones can capture the audio from audio source 108 and transmit audio streams 110A and 110B that include the audio. The teleconference computing system 104 can evaluate the audio streams 110A and 110B and determine that the audio stream 110A is of a higher quality than the audio stream 110B (e.g., based on signal quality metrics, device specifications, prior audio streams, etc.). Based on the evaluation, the teleconference computing system 104 can broadcast audio stream 110 to a participant computing device 112 that does not belong to the cohort of participant computing devices. Thus, by selecting the highest quality microphone in any particular scenario, the teleconference computing system 104 can substantially reduce the utilization of network resources while ensuring that the broadcast received by participant computing device 112 includes the highest quality audio available.

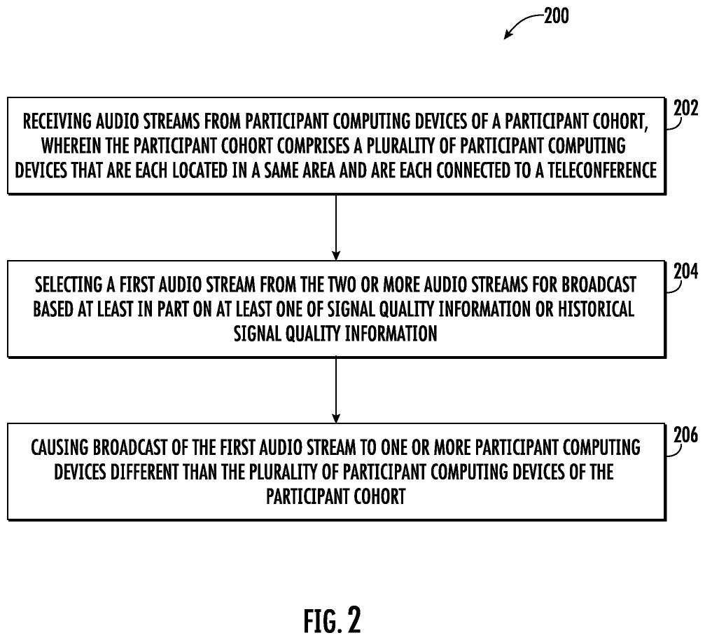

FIG. 2 is a flow diagram of an example method 200 for performing audio stream selection for representation of a cohort of multiple co-located participant computing devices for a teleconference, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the stream selector module 106 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible

At operation 202, processing logic of a computing system (e.g., a teleconference computing system, etc.) can receive two (or more) audio streams from two or more participant computing devices of a participant cohort. It should be noted that an audio “stream” can refer to the discrete, or continuous, transmission of any type or manner of audio data. In some implementations, the two or more audio streams can each include audio packet(s) (e.g., one audio packet, ten audio packets, etc.). Alternatively, in some implementations, an audio stream can refer to a continuous transmission of audio data captured by the participant computing device.

The participant cohort can include a plurality of participant computing devices that are each located in a “same” area and are each connected to a teleconference orchestrated by the computing system. A participant “cohort” can refer to a group of participant computing devices that are grouped by location due to being located in the same area. More specifically, each of the participant computing devices in a participant cohort can be co-located with each other (e.g., in the same room, in the same semi-enclosed space, etc.). In other words, the participant computing devices of a participant cohort are generally located within a certain distance of each other (e.g., an audible distance). For example, if an audio source produces audio (e.g., a participant produces a spoken utterance, a glass shatters on the ground, etc.), all of the participant computing devices of a participant cohort will likely be located close enough to detect and capture the audio with their associated audio capture devices (e.g., microphones). Similarly, if audio is played through the speakers of one participant computing device, it is likely that speaker playback will be audible for all participants associated with the participant computing devices of the participant cohort.

The teleconference orchestrated by the computing system (e.g., a physical server system, virtualized computing device(s), a cloud system, etc.) can be any type or manner of live exchange of audio data (e.g., AR/VR conferencing, audioconferencing, videoconferencing, multimedia conferencing, etc.). In some implementations, the teleconference can be a hosted teleconference in which audio data is transmitted by one participant computing device to the computing system and then broadcast by the computing system to other participant computing devices. Additionally, or alternatively, in some implementations, the teleconference can be a peer-to-peer teleconference that utilizes peer-to-peer connections for the direct exchange of audio data between participant computing devices.

In some implementations, the computing system can form the participant cohort prior to receiving the audio streams. For example, in some implementations, prior to receiving the audio streams, the computing system can obtain information that indicates a device location for each device in the cohort. The information can indicate the device location in any manner. For example, the information can be location coordinates, a zip code, a Global Positioning System (GPS) signal, etc. For another example, the information can be audio data received previously from the participant computing devices. For example, the computing system can determine that multiple participant computing devices are co-located by receiving audio streams from each participant computing device in the cohort and detecting the presence of common audio, or audio features, in each stream (e.g., the voice of one participant included in each audio stream).

Based on the information, the computing system can make a determination that the participant computing devices are co-located, and can form the cohort based on the determination. For example, in some implementations, the computing system can provide information to the participant computing devices that indicates to the devices that they are assigned to the participant cohort. Additionally, or alternatively, in some implementations, the computing system can modify a graphical user interface associated with the teleconference to represent the participant computing devices using a single representational entity. For example, if the participant computing devices are all located in the same office room, the computing system can represent the participant cohort as “room A” within the graphical user interface.

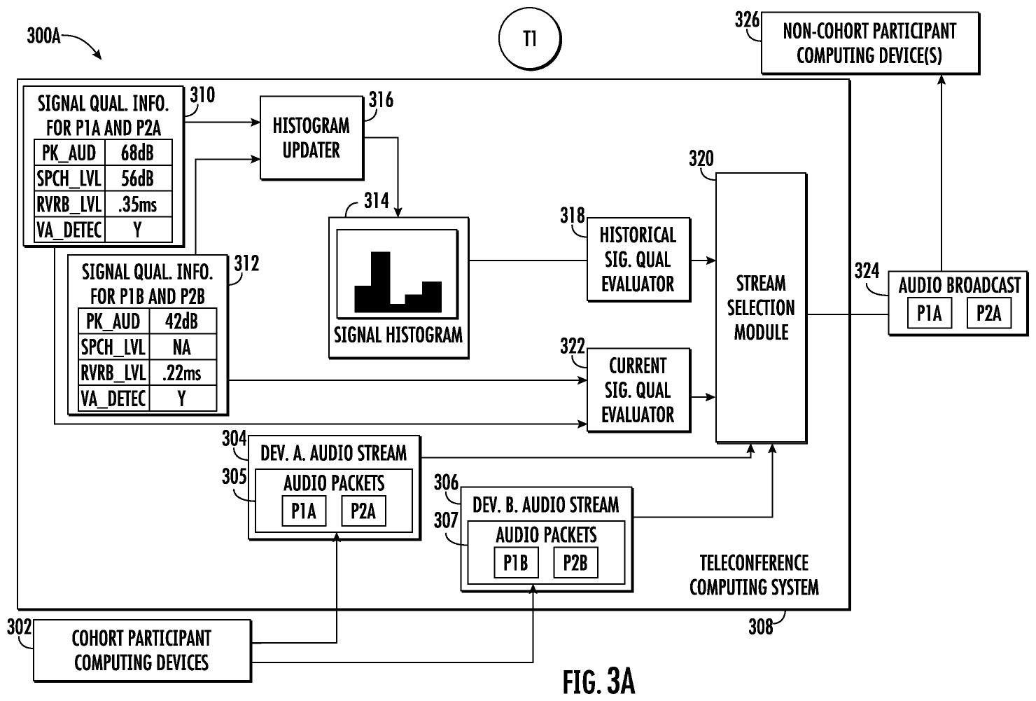

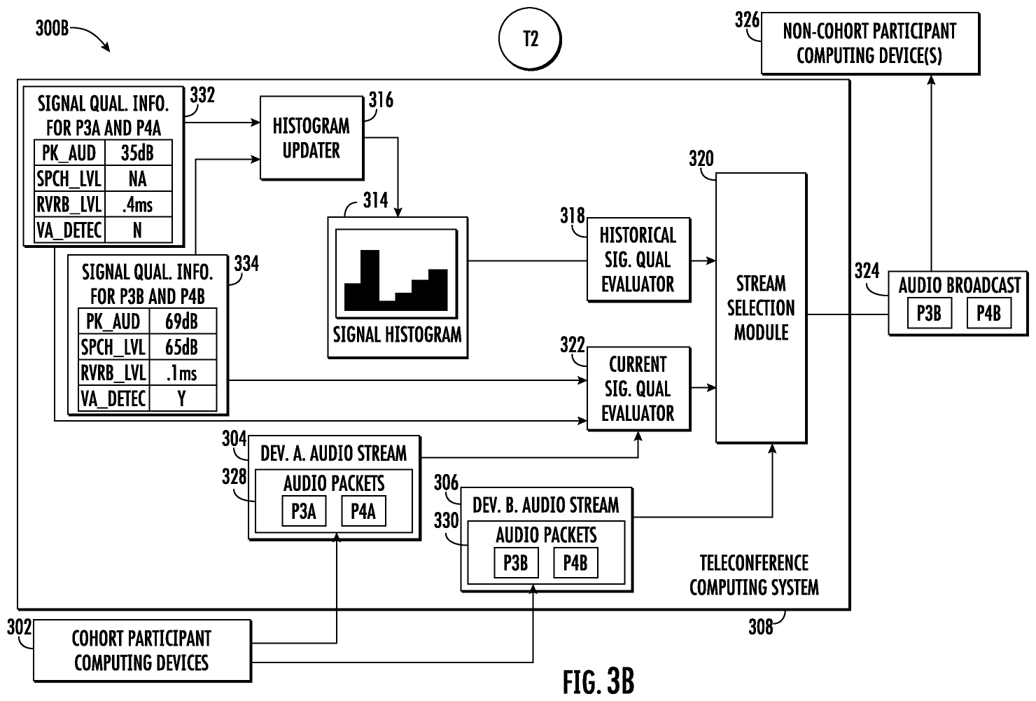

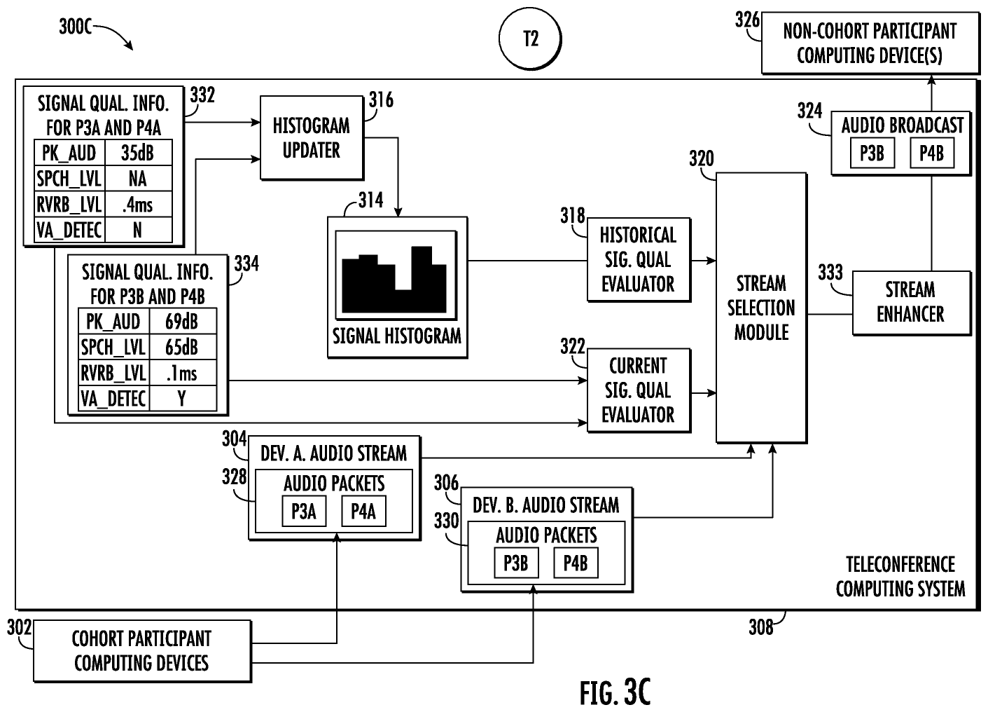

At operation 204, the processing logic of the computing system can select an audio stream from the two or more audio streams for broadcast. In some implementations, the computing system can select the stream for broadcast based at least in part on signal quality information that indicates a signal quality of the audio streams. In some implementations, the signal quality information can indicate a microphone quality, or quality of a signal captured at a microphone. For example, the signal quality information can indicate a current peak audio level, peak noise level, speech level, noise level, speech reverb level, voice activity, signal-to-noise ratio etc. Evaluation of signal quality information will be discussed in greater detail with regards to FIGS. 3A-3C.

In some implementations, the signal quality information can be obtained from the participant computing devices alongside the audio streams. More specifically, the participant computing devices can transmit signal quality information to the computing system that indicates a signal quality for the audio captured by the participant computing device. For example, a participant computing device transmitting an audio stream, and/or the microphone associated with the participant computing device, may possess the capability to determine signal quality metrics while capturing audio (e.g., signal-to-noise ratio, reverberation levels, etc.). The participant computing device can provide the signal quality metrics to the computing system alongside the audio stream.

Additionally, or alternatively, in some implementations the computing system can generate signal quality information based on the audio stream received by the computing system. For example, the computing system can perform any number of conventional audio analysis techniques to the audio stream to obtain signal quality metrics indicative of a signal quality of the audio stream. For another example, the computing system can process the audio stream with a machine-learned model trained to evaluate the signal quality of an audio stream.

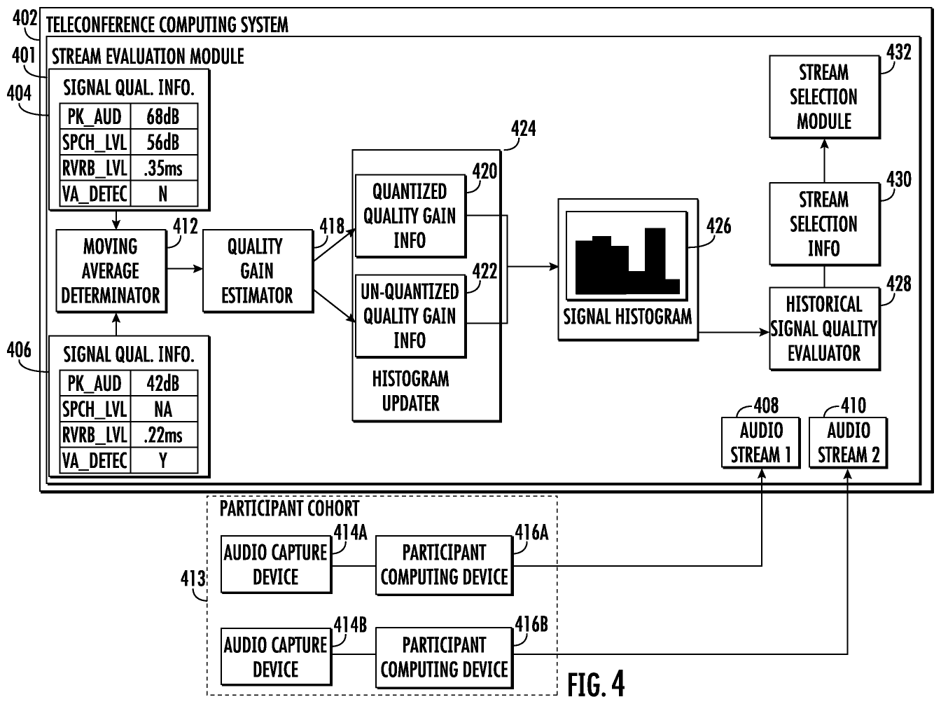

Additionally, or alternatively, in some implementations, the computing system can select the stream for broadcast based at least in part on the historical signal quality information. The historical signal quality information can indicate a signal quality associated with prior audio streams received from the participant computing devices. For example, the historical signal quality information can be a signal histogram calculated based on audio streams received previously from the participant computing devices. The evaluation of historical signal quality information will be discussed in greater detail with regards to FIGS. 3A-3C and 4.

In some implementations, the computing system can iteratively select between the streams provided by the participant computing devices. For example, the audio streams received by the computing system can each include N audio packets (e.g., N=1 packet, N=10 packets, etc.). The computing system can perform M iterations where M is less than or equal to N. Across the M iterations, the computing system can sequentially select audio packet(s) for transmission from any of the sets of audio packets. As a more specific example, a smartphone device and a laptop computing device can both transmit audio streams including N packets to the computing system. For a first iteration, the computing system can select packets 1-5 from the stream transmitted by the smartphone device for broadcast. For the next iteration, the computing system can select packets 6-10 from the stream transmitted by the laptop computing device for broadcast. In such fashion, the computing system can switch between provided audio streams on a per-packet or per-packets basis.

At operation 206, the processing logic of the computing system can cause broadcast of the audio stream to other participant computing devices different than the plurality of participant computing devices of the participant cohort. In some implementations, the computing system can cause broadcast of the first audio stream by broadcasting the first audio stream to the other participant computing devices. Alternatively, the computing system can cause broadcast of the audio stream by instructing the participant computing device associated with the audio stream to broadcast it to the other participant computing devices (e.g., via a peer-to-peer connection, etc.).

In some implementations, prior to causing broadcast of the first audio stream, the computing system can enhance the audio stream based at least in part on the other audio stream(s) provided by other participant computing device(s) in the participant cohort. For example, the selected stream can possess a highest overall quality, but may have failed to capture a certain portion of audio that another audio stream correctly captured. The selected stream can be enhanced with that portion of the other audio stream to increase the overall quality of the selected stream.

In some implementations, the computing system can select an initial portion of the audio stream for broadcasting. The computing system can obtain additional signal quality information that indicates a signal quality of a subsequent portion of the audio streams from the participant computing devices, and can select a subsequent portion from a different audio stream than the stream from which the initial portion was selected. For example, the computing system can receive two audio streams from a smartphone device and a laptop device. The computing system can select seconds 0-5 of the audio stream from the smartphone device for broadcast. Based on the additional signal quality information, the computing system can select seconds 6-10 of the other audio stream for broadcast. In such fashion, the computing system can dynamically and iteratively switch between audio streams based on the current and/or historic signal quality of associated audio capture devices.

FIG. 3A depicts a more detailed data flow diagram 300A for selecting an audio stream to represent a cohort of multiple co-located participant computing devices for a teleconference at a first time T1 according to some implementations of the present disclosure. More specifically, at cohort participant computing devices 302 can be assigned to a participant cohort. At time T1, the participant computing devices 302 can transmit audio streams 304 and 306 to teleconference computing system 308. The teleconference computing system can receive audio packets 305 from the audio stream 304, and can receive audio packets 307 from the audio stream 306. It should be noted that, although two audio packets are depicted in FIG. 3A, implementations of the present disclosure are not limited to the utilization of two audio packets. Rather, implementations of the present disclosure can evaluate any number of audio packet(s) or can iteratively evaluate audio streams in some manner other than on a per-packet basis.

Specifically, as used herein, an “audio stream” can be a continuous connection that provides a flow of audio data packets. For example, one of the cohort participant computing devices 302 can initiate a socket connection with the teleconference computing system 308, and can transmit a continuous flow of audio packets across the socket connection to form the audio stream 304. Alternatively, in some implementations, an audio stream can refer to one or more discrete data transmissions over a period of time. For example, rather than initiating a socket connection with the teleconference computing system 308, one of the cohort participant computing devices 302 can transmit sets of audio packets at regular intervals. As such, it should be broadly understood that an audio stream can refer to the transmission of multiple units of audio data from a participant computing device to the teleconference computing system 308.

An audio packet, as used herein, can refer to any type of data that carries a portion (or all) of a digitized audio signal. For example, the audio packets 305 can, in some implementations, be structured to include headers that indicate various information (e.g., target, ping, codec type, source ID, packet sequence number, etc.) and a payload (e.g., the audio data). For another example, the audio packets 305 can be encoded audio packets that are decoded by the teleconference computing system 308 prior to broadcast.

The teleconference computing system 308 can obtain signal quality information 310 that indicates a current signal quality for the audio stream 304. The teleconference computing system 308 can also obtain signal quality information 312 that indicates a current signal quality for the audio stream 306. For example, the teleconference computing system 308 can determine the signal quality information 310 and 312 by evaluating the audio streams 304 and 306 as they are received by the teleconference computing system. For another example, the teleconference computing system 308 can obtain the signal quality information 310 and 312 from the cohort participant computing devices 302.

The signal quality information 310 and 312 can indicate a current signal quality of the audio streams 304 and 306. In some implementations, the signal quality information 310 and 312 can include signal quality metrics for the audio streams 304 and 306. To follow the depicted example, signal quality information 310 indicates a peak audio metric of 68 dB, a speech level of 55 dB, a reverberation metric of 0.35 ms, and a positive voice detection metric for audio stream 304. Similarly, signal quality information 312 indicates a peak audio metric of 42 dB, a speech level of NA (i.e., speech is not detected), a reverberation metric of 0.22 ms, and a negative voice detection metric for audio stream 306. More generally, the signal quality information 310 and 312 can include any type or manner of signal quality metrics for the audio streams 304 and 306.

In some implementations, the signal quality information 310 and 312 can indicate a quality of a microphone used to capture the audio of the audio streams 304 and 306. For example, signal quality metrics, such as a peak audio metric or reverberation metric, can be measured at the microphone while capturing the audio and provided to the teleconference computing system 308 alongside the audio streams 304 and 306.

In some implementations, the teleconference computing system 308 can obtain historical signal quality information that indicates a signal quality associated with prior audio streams received from the cohort participant computing devices 302. To follow the depicted example, the teleconference computing system 308 can include a signal histogram 314 that is based on previously received audio streams from the cohort participant computing devices 302. For example, the signal histogram 314 can be associated with the participant computing device of the cohort participant computing devices 302 that transmits the audio stream 304, and the participant computing device of the cohort participant computing devices 302 that transmits the audio stream 306.

The teleconference computing system 308 can update the signal histogram 314 using histogram updater 316. More specifically, the signal histogram 314 can be updated based on the current signal quality information 310 and 312. For example, the signal histogram 314 can be updated based on the signal quality information 310 and the signal quality information 312.

In some implementations, the signal histogram can be associated with audio capture devices (e.g., microphones) used to capture the audio of associated audio streams. More specifically, in some implementations, a signal histogram can track the number of iterations in which a microphone is selected as the “best” microphone within a cohort of participant computing devices. To follow the depicted example, the histogram updater 316 can iteratively evaluate signal quality information 310 and 312 as it is received for audio packets of the audio streams 304 and 306. For each packet from audio streams 304 and 306, or sets of packets, the histogram updater 316 can identify a “best” microphone for the iteration based on signal quality information 310 and 312, and can update the signal histogram 314 based on the identification.

In such fashion, a microphone that most consistently is identified as the “best” microphone is more likely to be selected by the stream selection module 320. More specifically, a microphone can be selected based on an evaluation of the signal quality histogram to select a microphone that has a highest metric (e.g., quality metric, etc.) over a certain period of time. Updating of the signal histogram will be discussed in greater detail with regards to FIG. 4.

It should be noted that historical signal quality information can be stored in any manner, and is not limited to histograms or the like. For example, the signal quality information can be a store of previously obtained signal quality information. For another example, the signal quality information can be an encoding, or latent representation, of previously obtained signal quality information. For example, the histogram updater 316 can store and update an embedding, or other type or latent representation, that represents a historical signal quality of a microphone used to capture an audio stream. The histogram updater 316 can provide this embedding to the stream selection module 320 for selection of the stream for broadcast.

Before, or after, the signal histogram 314 is updated, the histogram can be evaluated by the teleconference computing system using the historical signal quality evaluator 318. The historical signal quality evaluator 318 can evaluate the signal histogram 314 to determine metrics associated with the signal histogram 314. For example, the historical signal quality evaluator can evaluate the signal histogram 314 to determine metrics for the audio streams 304 and 306. The metrics determined using the signal histogram 314 can be provided to the stream selection module 320. In some implementations, the metrics determined by the historical signal quality evaluator 318 can be the number of data points for each device, or stream, within a histogram. More specifically, if the histogram 314 indicates that the microphone used to capture audio stream 304 has historically been identified as the “best” microphone 15 times, and that the microphone used to capture audio stream 306 has historically been identified as the “best” microphone 9 times, the histogram signal quality evaluator 318 can select a value of 15 and 9 to represent the audio streams 304 and 306.

The audio streams 304 and 306 can be provided to the current signal quality evaluator 322. The current signal quality evaluator 322 can evaluate the audio streams 304 and 306 to estimate a current quality difference between the two audio streams 304 and 306. More specifically, in some implementations, the current signal quality evaluator 322 can determine whether there is a per-packet difference in quality between the audio packets 305 and 307. For example, the current signal quality evaluator 322 can determine that audio packets 305 are a greater quality than audio packets 307. The current signal quality evaluator 322 can provide information to the stream selection module 320 that is indicative of the current signal quality of the audio streams 304 and 306.

The stream selection module 320 can select one of the audio streams 304 or 306 for broadcast. In some implementations, the stream selection module 320 can select the stream for broadcast based on the signal histogram 314. For example, the stream selection module can select a stream based on information provided by the historical signal quality evaluator 318. Additionally, or alternatively, in some implementations, the stream selection module 320 can select the stream for broadcast based on the signal quality information 310 and 312. For example, the current signal quality evaluator 322 can evaluate the signal quality information 310 and 312 to determine whether the signal quality of both audio streams 304 and 306 is sufficient for broadcast, and the stream selector can select one of the audio streams 304 or 306 based on the evaluation.

The teleconference computing system 308 can broadcast the selected audio stream. To follow the depicted example, the teleconference computing system 308 can select audio packets 305 of the audio stream 304 for broadcast. The teleconference computing system 308 can then broadcast audio packets 305 in audio broadcast 324 to non-cohort participant computing devices 326 (e.g., participant computing devices that are not assigned to the same cohort as those of the cohort participant computing devices 302).

FIG. 3B depicts a more detailed data flow diagram 300B for switching an audio stream that represents a cohort of multiple co-located participant computing devices for a teleconference at a second time T2 according to some implementations of the present disclosure. Specifically, after broadcasting audio packets 305 in audio broadcast 324, at time T2 the teleconference computing system can receive audio packets 328 from the audio stream 304, and can receive audio packets 330 from the audio stream 306. The teleconference computing system 308 can obtain signal quality information 332 for the audio packets 328 and signal quality information 334 for the audio packets 330. More specifically, the signal quality information 332 can indicate a signal quality associated with the packets 328, and the signal quality information 334 can indicate a signal quality associated with the audio packets 330.

The teleconference computing system 308 can update the signal histogram 314 based on the signal quality information 332 and 334 using the histogram updater 316 as described with regards to FIG. 3A. Similarly, the current signal quality evaluator can evaluate the signal quality information 332 and 334 to determine a current signal quality associated with the audio packets 328 and 330.

Based on the historical signal quality information evaluated by the historical signal quality evaluator 318, and the signal quality information evaluated by the current signal quality evaluator 322, the stream selection module 320 can determine whether to switch the audio stream being broadcast from the audio stream 304 to the audio stream 306. More specifically, at time T1, the teleconference computing system 308 selects the audio stream 304 for broadcast in the audio broadcast 324. At time T2, with the receipt of additional packets 328 and 330, the teleconference computing system 308 can determine that audio stream 306 now has a higher “quality” than the audio stream 304.

To follow the depicted example, the signal quality information 332 indicates that there the voice detection metric for audio packets 328 is negative (i.e., voice activity is NOT detected) while the signal quality information 334 indicates that there the voice detection metric for audio packets 330 is positive (i.e., voice activity is detected). As such, the stream selection module 320 can determine that the audio stream being broadcast should be switched from audio stream 304 to audio stream 306. To do so, the stream selection module 320 can select audio packets 330 from the audio stream 306 for broadcast in the audio broadcast 324. The teleconference computing system 308 can then broadcast the audio packets 330 in the audio broadcast 324 to the non-cohort participant computing devices 326. In such fashion, the teleconference computing system 308 can dynamically switch between streams provided by co-located devices to ensure that the highest quality stream is provided to other participants of the teleconference.

Alternatively, in some implementations, the stream selection module 320 can determine to refrain from switching the audio stream being broadcast from audio stream 304 to audio stream 306. For example, assume that the voice detection metric for audio packets 328 is negative due to a lull in conversation, and that the voice detection metric for audio packets 330 is positive due to background noise or a failure by the echo cancellation module. The stream selection module 320 can analyze both the audio packets 328 and 330 to determine that, although the voice detection metric is negative for audio packets 328 and positive for audio packets 330, the positive voice detection metric for audio packets 330 is likely to be caused by failed echo cancellation and thus it is still advantageous to continue broadcasting the audio stream 304.

FIG. 3C depicts a data flow diagram 300C for enhancing an audio stream that represents a cohort of multiple co-located participant computing devices for a teleconference at a second time T2 according to some implementations of the present disclosure. More specifically, at time T2, the teleconference computing system 308 can determine that a selected audio stream can be enhanced using another received audio stream. To follow the depicted example, the stream selection module 320 can select audio packets 330 from audio stream 306 for broadcast in audio broadcast 324 as described with regards to FIG. 3B.

However, the stream selection module 320 can also detect that the audio packets 330 of audio stream 306 can be enhanced using audio packets 328 from audio stream 304. For example, assume that packet P4B of audio packets 330 is unable to be decoded by the teleconference computing system 308. Conventionally, this packet can be skipped when broadcasting the audio stream 306. However, due to the co-location of the cohort participant computing devices 302, it is likely that the audio data included in the packet P4B is also captured in corresponding packet P4A of the audio packets 328.

As such, the teleconference computing system 308 can utilize stream enhancer 333 to enhance the audio stream 306 by mixing the audio streams 304 and 306 for broadcast. More specifically, the stream enhancer 333 can replace any of the audio packets 330 that are unsuited for broadcast with corresponding audio packets from the audio packets 328. In such fashion, the teleconference computing system 308 can generate, or synthesize, an audio stream for broadcast that is higher quality than any individual stream received by the teleconference computing system 308.

Alternatively, in some implementations, the teleconference computing system 308 can enhance an audio stream in a manner other than packet replacement. More specifically, in some implementations, the stream enhancer 333 can be a machine-learned model that is trained to process multiple audio streams to generate an enhanced audio stream for broadcast. For example, the stream enhancer 333 can process the audio packets 328 and audio packets 330 to generate enhanced audio packets for transmission. Alternatively, the stream enhancer 333 can utilize any other type of conventional audio enhancement technique on the audio stream selected for broadcast (e.g., audio upscaling, format conversion, etc.).

FIG. 4 is a block diagram 400 for selecting an audio stream for broadcast based on signal quality information and historical signal quality information according to some implementations of the present disclosure. Specifically, the teleconference computing system 402 can respectively obtain signal quality information 404 and signal quality information 406 for audio streams 408 and 410 at a stream evaluation module 401 as described with regards to FIGS. 3A-3C. The stream evaluation module 401 can include a moving average determinator 412. Upon receiving packet(s) from the audio streams 408 and 410, the moving average determinator 412 can calculate a moving average for signal metrics based on the signal quality information 404 and 406.

More specifically, assume that the audio of audio stream 408 is captured using audio capture device 414A of participant computing device 416A, and that the audio of audio stream 410 is captured using audio capture device 414B of participant computing device 416B. The signal quality information 404 can include quality metrics for the signal captured at the audio capture device 414A, and the signal quality information 406 can include quality metrics for the signal captured at the audio capture device 414B. Assume that audio stream 408 is currently being broadcast by the teleconference computing system 402, and as such, that the audio capture device 414A is the “active” microphone for the participant cohort 413.

The moving average determinator 412 can determine a moving average of the signal quality information 404 and 406, and can provide the moving averages to the quality gain estimator 418. Based on the current active audio capture device (e.g., audio capture device 414A), the quality gain estimator 418 can normalize the signal quality information with regards to the signal of the audio capture device 414A. For example, the quality gain estimator 418 can normalize the signal metrics for the audio capture device 414B in the following manner in which the audio capture device 414B is represented as mic_2:

$$\begin{matrix}speech Level {Normalizer}_{mic \_ 2} = \frac{1}{speech {level}_{current active microphone}} \\ Signal - To - Noise Ratio ( SNR ) {normalizer}_{mic \_ 2} = \frac{1}{S N {R}_{current active microphone}} \\ {reverbNormalizer}_{mic \_ 2} = \frac{1}{{reverb}_{current active microphone}}\end{matrix}$$

Once normalized, the quality gain estimator 418 can estimate a speech level gain, a signal to noise ratio (SNR) gain, and a reverb gain by calculating a product of the signal levels and corresponding normalizer. For example, for the audio capture device 414B, the quality gain estimator 418 can estimate speech level gain, SNR gain, and reverb gain in the following manner in which the audio capture device 414B is represented as mic_2:

$$Sp eechLevel {Gain}_{mic \_ 2} = {sp eechLevelNormalizer}_{mic \_ 2} * smoothedAverageSpeech {RMS}_{mic \_ 2} \qquad ( 1 )$$

$${SNR Gain}_{mic \_ 2} = {SNR Normalizer}_{mic \_ 2} * smoothedAverage SNR {RMS}_{mic \_ 2} \qquad ( 2 )$$

$${ReverbGain}_{mic \_ 2} = {ReverbNormalizer}_{mic \_ 2} * smoothedAverageReverb {RMS}_{mic \_ 2} \qquad ( 3 )$$

Once calculated, the values evaluated in equations (1), (2), and (3) are used by the quality gain estimator 418 to estimate a quantized quality gain for the audio capture device 414B such as:

$${QuantizedQualityGain}_{mic \_ 2} = α . {SpeechLevelQualityGain}_{mic \_ 2} + β . {SNR LevelQualityGain}_{mic \_ 2} + . {reverbLevelQualityGain}_{mic \_ 2}$$

$$Where SpeechLevel {QualityGain}_{mic \_ 2} is :$$

$$\begin{matrix}\begin{matrix}- 2 , & if SpeechLevel {Gain}_{mic \_ 2} <\end{matrix} - 20 dB , \\ \begin{matrix}- 1 , & if - 20 dB <\end{matrix} {SpeechLevelGain}_{mic \_ 2} < - 10 dB , \\ \begin{matrix}0 , & if - 10 dB <\end{matrix} {SpeechLevelGain}_{mic \_ 2} < 10 dB , \\ \begin{matrix}1 , & if 10 dB <\end{matrix} {SpeechLevelGain}_{mic \_ 2} < 20 dB , \\ \begin{matrix}otherwise , & 2.\end{matrix}\end{matrix}$$

The quality gain estimator 418 can calculate the values for SNRLevelQualityGain_{mic_2} and reverbLevelQualityGain_{mic_2} in a similar manner. Each of values α, β, and γ can be described in quantized quality gain information 420. Similarly, the quality gain estimator 418 can estimate unquantizedQualityGain_{mic_2}=SNRGain_{mic_2}*ReverbGain_{mic_2}, which can be described by unquantized quality gain information 422.

Signal histogram 426 can indicate prior signal quality information. In some implementations, the signal histogram 426 indicates prior signal quality associated with audio capture devices 414A and 414B. Alternatively, in some implementations, the signal histogram 426 indicates prior signal quality associated with previously received audio streams from participant computing devices 416A and 416B.

The histogram updater 424 can update signal histogram 426 based on the quantized quality gain information 420 and the unquantized quality gain information 422. Specifically, the histogram updater can determine which of the audio capture devices 414A and 414B is the “best” capture device based on which device has a higher QuantizedQualityGain. If both audio capture devices 414A and 414B have the same QuantizedQualityGain, the histogram updater 424 can select the audio capture device with the highest unQuantizedQualityGain. The histogram of whichever audio capture device is selected can be incremented. If the histogram size is greater than a maximum histogram capacity, the oldest values in the histogram can be removed.

Once the signal histogram 426 is updated, the historical signal quality evaluator 428 can determine stream selection information 430 based on the signal histogram 426. More specifically, the historical signal quality evaluator 428 can determine the number of audio capture devices transmitting audio streams that have a higher histogram value than the “currently active” audio capture device. For example, as the audio capture device 414A is the “currently active” audio capture device, the historical signal quality evaluator 428 can determine whether the audio capture device 414B has a higher histogram value. If the audio capture device 414B does have a higher histogram value, the historical signal quality evaluator 428 can designate the audio capture device 414B as a candidate device.

The historical signal quality evaluator 428 can estimate a stream selection value to indicate whether the stream selection module 432 should switch from the audio capture device 414A (e.g., or the audio stream associated with audio capture device 414A) to the audio capture device 414B (e.g., or the audio stream associated with audio capture device 414B.) For example, the historical signal quality evaluator 428 can calculate an initial stream selection value as a current number of data points for the corresponding stream in the histogram (e.g., a quantity of values in the histogram) times a constant. For example, if the signal histogram 426 includes 10 prior values for audio capture device 414B, and the constant is 0.05, the initial stream selection value can be determined by the historical signal quality evaluator 428 to be 0.5. In some implementations, the historical signal quality evaluator 428 can then normalize the initial stream selection value by the number of candidate devices. The stream selection information 430 can indicate the stream selection value determined by the historical signal quality evaluator 428.

Based on the stream selection information 430, the stream selection module 432 can determine whether to switch from the audio stream 408 associated with the audio capture device 414A to the audio stream 410 associated with the audio capture device 414B. In some implementations, the stream selection module 432 can determine whether an audio capture device, or the stream associated with an audio capture device, has been switched to recently. For example, if the candidate microphone to be switched to was recently switched from, the stream selection module 432 can implement a delay so that streams are not rapidly switched between. In some implementations, if the stream selection module 432 switches between audio streams, the teleconference computing system 402 can apply a smoothing gain to the audio stream so that the switch between audio streams is less perceptible to listeners.

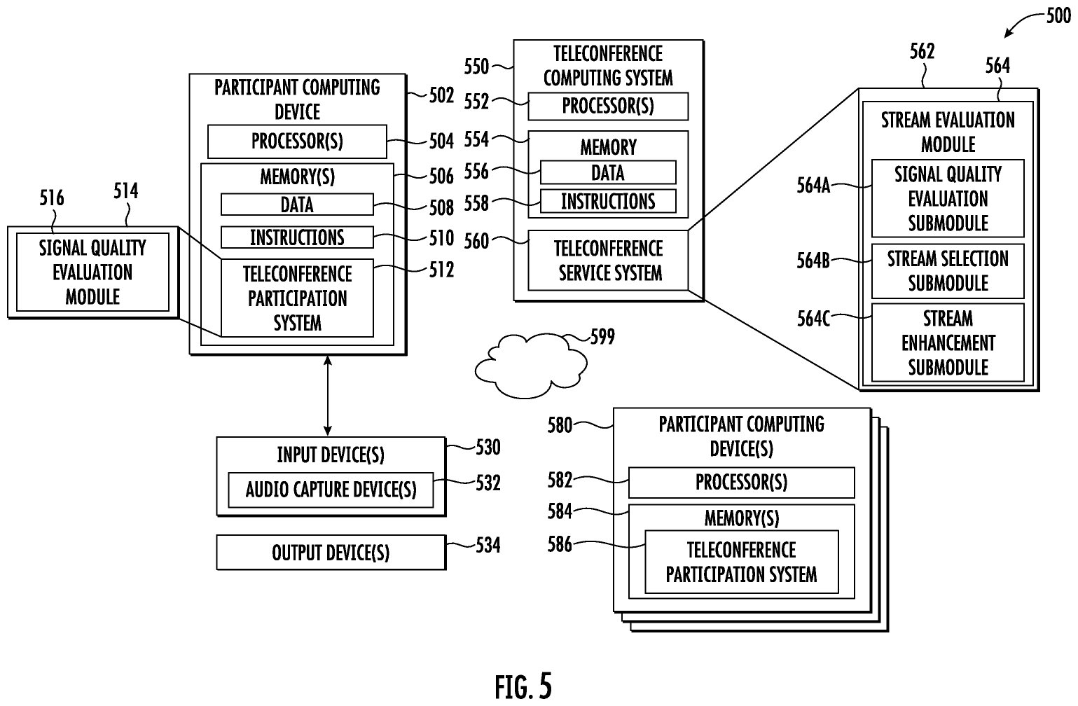

FIG. 5 depicts a block diagram of an example computing environment 500 that performs audio stream selection for representation of a cohort of co-located participant computing devices according to example implementations of the present disclosure. The computing environment 500 includes a participant computing device 502 that is associated with a participant in a teleconference, a teleconference computing system 550, and, in some implementations, other participant computing device(s) 580 respectively associated with other participants(s) in the teleconference.

The participant computing device 502 can be any type of computing device, such as, for example, a personal computing device (e.g., laptop or desktop), a mobile computing device (e.g., smartphone or tablet), a gaming console or controller, a wearable computing device (e.g., an virtual/augmented reality device, etc.), an embedded computing device, a broadcasting computing device (e.g., a webcam, etc.), etc.

In particular, the participant computing device 502 can, in some implementations, be a computing system for participation in teleconferences. For example, the participant computing device 502 can capture audio from an audio source using an audio capture device, such as a microphone. The participant computing device 502 can provide an audio stream that includes the captured audio to the teleconference computing system 550. To do so, the participant computing device 502 can perform any operations necessary to establish the continuous transfer of audio data from the participant computing device 502 to the teleconference computing system 550. For example, the participant computing device 502 can encode audio captured using the audio capture device (e.g., by packaging the audio in audio packets, etc.). For another example, the participant computing device 502 can establish a connection, such as a socket connection, for streaming of audio (e.g., audio packets) from the participant computing device 502 to the teleconference computing system 550.

The participant computing device 502 includes processor(s) 504 and memory(s) 506. The processor(s) 504 can be any suitable processing device (e.g., a processor core, a microprocessor, an ASIC, an FPGA, a controller, a microcontroller, etc.) and can be one processor or processors that are operatively connected. The memory 506 can include non-transitory computer-readable storage media(s), such as RAM, ROM, EEPROM, EPROM, flash memory devices, magnetic disks, etc., and combinations thereof. The memory 506 can store data 508 and instructions 510 which are executed by the processor 504 to cause the participant computing device 502 to perform operations.

In particular, the memory 506 of the participant computing device 502 can include a teleconference participation system 512. The teleconference participation system 512 can facilitate participation in a teleconference by a participant associated with the participant computing device 502 (e.g., a teleconference hosted or otherwise orchestrated by teleconference computing system 550, etc.). To facilitate teleconference participation, the teleconference participation system 512 can include service module(s) 514 which, by providing various services, can collectively facilitate participation in a teleconference.

For example, in some implementations, the teleconference service module(s) 514 can include a signal quality evaluation module 516. The signal quality evaluation module 516 can evaluate a signal quality of an audio signal captured using a microphone associated with the participant computing device 502. For example, the signal quality evaluation module can measure peak audio levels, peak noise levels, speech levels, voice activity levels, etc. of a signal captured using a microphone associated with the participant computing device 502. The signal quality evaluation module 516 can generate signal quality information descriptive of the signal quality of the microphone signal.

The participant computing device 502 can also include input device(s) 530 that receive inputs from a participant, or otherwise capture data associated with a participant. For example, the input device(s) 530 can include a touch-sensitive device (e.g., a touch-sensitive display screen or a touch pad) that is sensitive to the touch of a participant input object (e.g., a finger or a stylus). The touch-sensitive device can serve to implement a virtual keyboard. Other example participant input components include a microphone, a traditional keyboard, or other means by which a participant can provide user input.

In some implementations, the participant computing device 502 can include, or can be communicatively coupled to, input device(s) 530. For example, the input device(s) 530 can include a camera device that can capture two-dimensional video data of a participant associated with the participant computing device 502 (e.g., for broadcasting, etc.). In some implementations, the input device(s) 530 can include a number of camera devices communicatively coupled to the participant computing device 502 that are configured to capture image data from different perspectives for generation of three-dimensional pose data/representations (e.g., a representation of a user of the participant computing device 502, etc.).

In some implementations, the input device(s) 530 can include sensor devices configured to capture sensor data indicative of movements of a participant associated with the teleconference computing system 502 (e.g., accelerometer(s), Global Positioning Satellite (GPS) sensor(s), gyroscope(s), infrared sensor(s), head tracking sensor(s) such as magnetic capture system(s), an omni-directional treadmill device, sensor(s) configured to track eye movements of the user, etc.).

In particular, the input device(s) 530 can include audio capture device(s) 532. The audio capture device(s) 532 can be, or otherwise include, any type or manner of audio capture device, such as a microphone. In some implementations, the audio capture device(s) 532 can include multiple microphones. For example, the audio capture device(s) 532 can include an array of microphones that collectively capture audio from an audio source. Alternatively, in some implementations, the audio capture device(s) 532 can be a single microphone.

In some implementations, the participant computing device 502 can include, or be communicatively coupled to, output device(s) 534. Output device(s) 534 can be, or otherwise include, device(s) configured to output audio data, image data, video data, etc. For example, the output device(s) 534 can include a two-dimensional display device (e.g., a television, projector, smartphone display device, etc.). For another example, the output device(s) 534 can include display devices for an augmented reality device or virtual reality device.

The teleconference computing system 550 includes processor(s) 552 and a memory 554. The processor(s) 552 can be any suitable processing device (e.g., a processor core, a microprocessor, an ASIC, an FPGA, a controller, a microcontroller, etc.) and can be one processor or processors that are operatively connected. The memory 554 can include non-transitory computer-readable storage media(s), such as RAM, ROM, EEPROM, EPROM, flash memory devices, magnetic disks, etc., and combinations thereof. The memory 554 can store data 556 and instructions 558 which are executed by the processor 552 to cause the teleconference computing system 550 to perform operations.

In some implementations, the teleconference computing system 550 can be, or otherwise include, a virtual machine or containerized unit of software instructions executed within a virtualized cloud computing environment (e.g., a distributed, networked collection of processing devices), and can be instantiated on request (e.g., in response to a request to initiate a teleconference, etc.). Additionally, or alternatively, in some implementations, the teleconference computing system 550 can be, or otherwise include, physical processing devices, such as processing nodes within a cloud computing network (e.g., nodes of physical hardware resources).

The teleconference computing system 550 can facilitate the exchange of communication data within a teleconference using the teleconference service system 560. More specifically, the teleconference computing system 550 can utilize the teleconference service system 560 to encode, broadcast, and/or relay communications signals (e.g., audio input signals, video input signals, etc.), host chat rooms, relay teleconference invites, provide web applications for participation in a teleconference (e.g., a web application accessible via a web browser at a teleconference computing system, etc.), etc.

More generally, the teleconference computing system 550 can utilize the teleconference service system 560 to handle any frontend or backend services directed to providing a teleconference. For example, the teleconference service system 560 can receive and broadcast (i.e., relay) data (e.g., video data, audio data, etc.) between the participant computing device 502 and participant computing device(s) 580. For another example, the teleconference service system 560 can facilitate direct communications between the participant computing device 502 and participant computing device(s) 580 (e.g., peer-to-peer communications, etc.). A teleconferencing service can be any type of application or service that receives and broadcasts data from multiple participants. For example, in some implementations, the teleconferencing service can be a videoconferencing service that receives data (e.g., audio data, video data, both audio and video data, etc.) from some participants and broadcasts the data to other participants.

As an example, the teleconference service system 560 can provide a videoconference service for multiple participants. One of the participants can transmit audio and video data to the teleconference service system 560 using a participant device (e.g., participant computing device 502, etc.). A different participant can transmit audio data to the teleconference service system 560 with a different participant computing device. The teleconference service system 560 can receive the data from the participants and broadcast the data to each computing system.

As another example, the teleconference service system 560 can implement an augmented reality (AR) or virtual reality (VR) conferencing service for multiple participants. One of the participants can transmit AR/VR data sufficient to generate a three-dimensional representation of the participant to the teleconference service system 560 via a device (e.g., video data, audio data, sensor data indicative of a pose and/or movement of a participant, etc.). The teleconference service system 560 can transmit the AR/VR data to devices of the other participants. In such fashion, the teleconference service system 560 can facilitate any type or manner of teleconferencing services to multiple participants.

It should be noted that the teleconference service system 560 can facilitate the flow of data between participants (e.g., participant computing device 502, participant computing device(s) 580, etc.) in any manner that is sufficient to implement the teleconference service. In some implementations, the teleconference service system 560 can be configured to receive data from participants, decode the data, encode the data, broadcast the data to other participants, etc. For example, the teleconference service system 560 can receive encoded video data from the participant computing device 502. The teleconference service system 560 can decode the video data according to a video codec utilized by the participant computing device 502. The teleconference service system 560 can encode the video data with a video codec and broadcast the data to participant computing devices.

In particular, to facilitate teleconference participation, the teleconference service system 560 can include hosting module(s) 562 which fulfill or orchestrate various teleconferencing services that collectively provide a teleconference for participants.

For example, the teleconference hosting module(s) 562 can include a stream evaluation module 564. The stream evaluation module 564 can evaluate audio streams to determine which audio stream is the highest quality. More specifically, the stream evaluation module can include various submodules for evaluation of signal quality information, historical signal quality information, and histograms, and for stream selection.

For example, the stream evaluation module 564 can include a signal quality evaluation submodule 564A. The signal quality evaluation submodule 564A can evaluate current signal quality information that indicates a current signal quality for an audio stream, and/or the microphone that captured the streamed audio. In particular, the signal quality evaluation submodule 564A can evaluate the signal quality information to determine a current “best” microphone of a cohort of participant computing devices. For example, the signal quality evaluation submodule 564A can determine a “best” microphone (e.g., the microphone producing the highest quality audio signal) within a participant device cohort based on signal quality metrics included in the signal quality information. The signal quality evaluation submodule 564A can then update a signal histogram that track the number of iterations in which microphones are identified as being the “best” microphone within the participant cohort.

For another example, the stream evaluation module 564 can include a stream selection submodule 564B. The stream selection submodule 564B can select an audio stream based on evaluations made by the signal quality evaluation submodule 564A. More specifically, the stream selection submodule 564B can select a stream for broadcast as described with regards to FIGS. 3A-3C.

For another example, the stream evaluation module 564 can include a stream enhancement submodule 564C. The stream enhancement submodule 564C can enhance an audio stream based on additional audio streams received by the teleconference computing system 550. For example, the teleconference computing system 550 can receive an audio stream with a series of missing packets. The stream enhancement submodule 564C can replace the missing packets with corresponding packets from another audio stream from a co-located participant computing device. For another example, the stream enhancement submodule 564C can be, or otherwise include, a machine-learned model trained to process multiple audio streams to generate an enhanced audio stream. For yet another example, the stream enhancement submodule 564C can utilize various audio enhancement processes to enhance an audio stream received by the teleconference computing system 550 (e.g., audio upscaling, data format conversion, etc.).

In some implementations, the teleconference computing system 550 includes, or is otherwise implemented by, server computing device(s). In instances in which the teleconference computing system 550 includes multiple server computing devices, such server computing devices can operate according to sequential computing architectures, parallel computing architectures, or some combination thereof.

In some implementations, the transmission and reception of data by teleconference computing system 550 can be accomplished via the network 599. For example, in some implementations, the participant computing device 502 can capture video data, audio data, multimedia data (e.g., video data and audio data, etc.), sensor data, etc. and transmit the data to the teleconference computing system 550. The teleconference computing system 550 can receive the data via the network 599.

In some implementations, the teleconference computing system 550 can receive data from the participant computing device(s) 502 and 580 according to various encryption scheme(s) (e.g., codec(s), lossy compression scheme(s), lossless compression scheme(s), etc.). For example, the participant computing device 502 can encode audio data with an audio codec, and then transmit the encoded audio data to the teleconference computing system 550. The teleconference computing system 550 can decode the encoded audio data with the audio codec. In some implementations, the participant computing device 502 can dynamically select between a number of different codecs with varying degrees of loss based on conditions (e.g., available network bandwidth, accessibility of hardware/software resources, etc.) of the network 599, the participant computing device 502, and/or the teleconference computing system 550. For example, the participant computing device 502 can dynamically switch from audio data transmission according to a lossy encoding scheme to audio data transmission according to a lossless encoding scheme based on a signal strength between the participant computing device 502 and the network 599.

The teleconference computing system 550 and the participant computing device 502 can communicate with the participant computing device(s) 580 via the network 599. The participant computing device(s) 580 can be any type of computing device(s), such as, for example, a personal computing device (e.g., laptop or desktop), a mobile computing device (e.g., smartphone or tablet), a gaming console or controller, a wearable computing device (e.g., an virtual/augmented reality device, etc.), an embedded computing device, a broadcasting computing device (e.g., a webcam, etc.), or any other type of computing device.

The participant computing device(s) 580 includes processor(s) 582 and a memory 584 as described with regards to the participant computing device 502. Specifically, the participant computing device(s) 580 can be the same, or similar, device(s) as the participant computing device 502. For example, the participant computing device(s) 580 can each include a teleconference participation system 586 that includes at least some of the modules 514 of the teleconference participation system 512. For another example, the participant computing device(s) 580 can include, or can be communicatively coupled to, the same type of input and output devices as described with regards to input device(s) 530 and output device(s) 534 (e.g., device(s) 532, device(s) 536, etc.). Alternatively, in some implementations, the participant computing device(s) 580 can be different devices than the participant computing device 502, but can also facilitate teleconferencing with the teleconference computing system 550. For example, the participant computing device 502 can be a laptop and the participant computing device(s) 580 can be smartphone(s).

The network 599 can be any type of communications network, such as a local area network (e.g., intranet), wide area network (e.g., Internet), or some combination thereof and can include any number of wired or wireless links. In general, communication over the network 599 can be carried via any type of wired and/or wireless connection, using a wide variety of communication protocols (e.g., TCP/IP, HTTP. SMTP, FTP), encodings or formats (e.g., HTML, XML), and/or protection schemes (e.g., VPN, secure HTTP, SSL).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

The following definitions provide a detailed description of various terms discussed throughout the subject specification. As such, it should be noted that any previous reference in the specification to the following terms should be understood in light of these definitions.

Broadcast: as used herein, the terms “broadcast” or “broadcasting” generally refers to any transmission of data (e.g., audio data, video data, AR/VR data, etc.) from a central entity (e.g., computing device, computing system, etc.) for potential receipt by one or more other entities or devices. A broadcast of data can be performed to orchestrate or otherwise facilitate a teleconference that includes a number of participants. For example, a central entity, such as a teleconference server system, can receive an audio transmission from a participant computing device associated with one participant and broadcast the audio transmission to a number of participant computing devices associated with other participants of a teleconference session. For another example, a central entity can detect that direct peer-to-peer data transmission between two participants in a private teleconference is not possible (e.g., due to firewall settings, etc.) and can serve as a relay intermediary that receives and broadcasts data transmissions between participant computing devices associated with the participants. In some implementations, broadcast or broadcasting can include the encoding and/or decoding of transmitted and/or received data. For example, a teleconference computing system broadcasting video data can encode the video data using a codec. Participant computing devices receiving the broadcast can decode the video using the codec.

In some implementations, a broadcast can be, or otherwise include, wireless signaling that carries data, such as communications data, received in a transmission from a participant computing device. Additionally, or alternatively, in some instances, a broadcast can carry data obtained from a data store, storage device, content provider, application programming interface (API), etc. For example, a central entity can receive transmissions of audio data from a number of participant computing devices. The central entity can broadcast the audio data alongside video data obtained from a video data repository. As such, the broadcast of data is not limited to data received via transmissions from participant computing devices within the context of a teleconference.

Communications data: as used herein, the term “communications data” generally refers to any type or manner of data that carries a communication, or otherwise facilitates communication between participants of a teleconference. Communications data can include audio data, video data, textual data, augmented reality/virtual reality (AR/VR) data, etc. As an example, communications data can collectively refer to audio data and video data transmitted within the context of a videoconference. As another example, within the context of an AR/VR conference, communications data can collectively refer to audio data and AR/VR data, such as positioning data, pose data, facial capture data, etc. that is utilized to generate a representation of the participant within a virtual environment. As yet another example, communications data can refer to textual content provided by participants (e.g., via a chat function of the teleconference, via transcription of audio transmissions using text-to-speech technologies, etc.).

Cloud: as used herein, the term “cloud” or “cloud computing environment” generally refers to a network of interconnected computing devices (e.g., physical computing devices, virtualized computing devices, etc.) and associated storage media which interoperate to perform computational operations such as data storage, transfer, and/or processing. In some implementations, a cloud computing environment can be implemented and managed by an information technology (IT) service provider. The IT service provider can provide access to the cloud computing environment as a service to various users, who can in some circumstances be referred to as “cloud customers.”

Participant: as used herein, the term “participant” generally refers to any user (e.g., human user), virtualized user (e.g., a bot, etc.), or group of users that participate in a live exchange of data (e.g., a teleconference such as a videoconference, etc.). More specifically, participant can be used throughout the subject specification to refer to user(s) within the context of a teleconference. As an example, a group of participants can refer to a group of users that participate remotely in a teleconference with their own participant computing devices (e.g., smartphones, laptops, wearable devices, teleconferencing devices, broadcasting devices, etc.). As another example, a participant can refer to a group of users utilizing a single participant computing device for participation in a teleconference (e.g., a videoconferencing device within a meeting room, etc.). As yet another example, participant can refer to a bot or an automated user (e.g., a virtual assistant, etc.) that participates in a teleconference to provide various services or features for other participants in the teleconference (e.g., recording data from the teleconference, providing virtual assistant services, providing testing services, etc.)

Teleconference: as used herein, the term “teleconference” generally refers to any communication or live exchange of data (e.g., audio data, video data, AR/VR data, etc.) between multiple participant computing devices. The term “teleconference” encompasses a videoconference, an audioconference, a media conference, an Augmented Reality (AR)/Virtual Reality (VR) conference, and/or other forms of the exchange of data (e.g., communications data) between participant computing devices. As an example, a teleconference can refer to a videoconference in which multiple participant computing devices broadcast and/or receive video data and/or audio data in real-time or near real-time. As another example, a teleconference can refer to an AR/VR conferencing service in which AR/VR data (e.g., pose data, image data, positioning data, audio data, etc.) sufficient to generate a three-dimensional representation of a participant is exchanged amongst participant computing devices in real-time. As yet another example, a teleconference can refer to a conference in which audio signals are exchanged amongst participant computing devices over a mobile network. As yet another example, a teleconference can refer to a media conference in which one or more different types or combinations of media or other data are exchanged amongst participant computing devices (e.g., audio data, video data, AR/VR data, a combination of audio and video data, etc.).

Transmission: As used herein, the term “transmission” generally refers to any sending, providing, etc. of data (e.g., communications data) from one entity to another entity. For example, a participant computing device can directly transmit audio data to another participant computing device. For another example, a participant computing device can transmit video data to a central entity orchestrating a teleconference, and the central entity can broadcast the audio data to other entities participating in the teleconference. Transmission of data can occur over any number of wired and/or wireless communications links or devices. Data can be transmitted in various forms and/or according to various protocols. For example, data can be encrypted and/or encoded prior to transmission and decrypted and/or decoded upon receipt.

Transmission quality: As used herein, the term “transmission quality” generally refers to a perceivable quality of a transmission of communications data. In particular, transmission quality can refer to, or otherwise account for a technical quality of the transmission, such as degree of loss associated with the transmission, a resolution, a bitrate, etc. Additionally, or alternatively, the term transmission can refer to a semantic quality of the transmission, such as a degree of background noise, a clarity associated with spoken utterances of participants, etc. As such, it should be broadly understood that the “transmission quality” of a transmission can be determined in accordance with a variety of factors.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method, comprising:
receiving, by a teleconference computing system comprising one or more computing devices, two or more audio streams from two or more respective participant computing devices of a participant cohort, wherein the participant cohort comprises a plurality of participant computing devices that are each located in a same area and are each connected to a teleconference orchestrated by the teleconference computing system;
obtaining, by the teleconference computing system, signal quality information indicative of a signal quality associated with each of the two or more audio streams;
updating, by the teleconference computing system, a signal histogram based on the signal quality information, wherein the signal histogram is indicative of a historical signal quality for audio streams received from the plurality of participant computing devices of the participant cohort, and wherein the signal histogram is further indicative of a quantity of audio streams from the two or more respective participant computing devices previously selected for broadcast during the teleconference;
selecting, by the teleconference computing system, a first audio stream from the two or more audio streams for broadcast based at least in part on the signal histogram, wherein selecting the first audio stream comprises:
determining, by the teleconference computing system based on the signal histogram, that the first audio stream has not been previously selected for broadcast within a certain period of time; and
causing, by the teleconference computing system, broadcast of the first audio stream to one or more participant computing devices different than the plurality of participant computing devices of the participant cohort.

2. The computer-implemented method of claim 1, wherein selecting the first audio stream comprises selecting, by the teleconference computing system, a first portion of the first audio stream from the two or more audio streams for broadcast based at least in part on the signal histogram and a portion of the signal quality information indicative of a signal quality associated with a first portion of each of the two or more audio streams; and
wherein causing the broadcast of the first audio stream comprises causing, by the teleconference computing system, broadcast of the first portion of the first audio stream to the one or more participant computing devices different than the plurality of participant computing devices of the participant cohort.

3. The computer-implemented method of claim 2, wherein the method further comprises:
obtaining, by the teleconference computing system, second signal quality information indicative of a signal quality associated with a second portion of each of the two or more audio streams;
selecting, by the teleconference computing system, the second portion of a second audio stream different than the first audio stream from the two or more audio streams for broadcast based on the second signal quality information; and
causing, by the teleconference computing system, broadcast of the second portion of the second audio stream to the one or more participant computing devices different than the plurality of participant computing devices of the participant cohort.

4. The computer-implemented method of claim 3, wherein selecting the second portion of the second audio stream different than the first audio stream from the two or more audio streams for broadcast comprises:
determining, by the teleconference computing system based on the signal histogram, that the second audio stream has not been previously selected for broadcast within a certain period of time.

5. The computer-implemented method of claim 1, wherein receiving the two or more audio streams from the two or more respective participant computing devices of the participant cohort comprises receiving, by the teleconference computing system, a first set of N audio packets from a first participant computing device of the participant cohort and a second set of N audio packets from a second participant computing device of the participant cohort, where N is greater than or equal to one.

6. The computer-implemented method of claim 5, wherein selecting the first audio stream of the two or more audio streams for transmission comprises:
for M iterations, where M is less than or equal to N:
sequentially selecting, by the teleconference computing system based on the signal histogram, one or more audio packets for transmission from either the first set of N audio packets or the second set of N audio packets; and
causing, by the teleconference computing system, broadcast of the one or more audio packets to the one or more participant computing devices different than the plurality of participant computing devices of the participant cohort.

7. (canceled)

8. The computer-implemented method of claim 1, wherein obtaining the signal quality information comprises receiving, by the teleconference computing system, the signal quality information from the two or more respective participant computing devices of the participant cohort.

9-10. (canceled)

11. The computer-implemented method of claim 1, wherein obtaining the signal quality information comprises:
respectively receiving, by the teleconference computing system, two or more sets of signal quality metrics for the two or more audio streams; and
estimating, by the teleconference computing system, the signal quality information indicative of the signal quality of each of the two or more audio streams.

12. The computer-implemented method of claim 11, wherein selecting the first audio stream from the two or more audio streams for broadcast based at least in part on the signal histogram comprises:
determining, by the teleconference computing system, two or more stream selection values for the two or more respective participant computing devices based on the signal histogram; and
selecting, by the teleconference computing system as the first audio stream, the first audio stream from the participant computing device with a highest stream selection value.

13. The computer-implemented method of claim 11, wherein each of the two or more sets of signal quality metrics comprises at least one of:
a peak audio level metric;
a peak noise level metric;
a speech level metric;
a noise level metric;
a speech reverb level metric; or
a voice activity metric.

14. The computer-implemented method of claim 1, wherein causing broadcast of the first audio stream comprises:
broadcasting, by the teleconference computing system, the first audio stream to the one or more participant computing devices; or
providing, by the teleconference computing system, instructions to the participant computing device associated with the first audio stream to broadcast the first audio stream to the one or more participant computing devices.

15. The computer-implemented method of claim 1, wherein causing the broadcast of the first audio stream comprises:
enhancing, by the teleconference computing system, the first audio stream based at least in part on a second audio stream of the two or more audio streams; and
broadcasting, by the teleconference computing system, the first audio stream to the one or more participant computing devices different than the plurality of participant computing devices of the participant cohort.

16. The computer-implemented method of claim 1, wherein, prior to receiving the two or more audio streams from the two or more respective participant computing devices of the participant cohort, the method comprises:
receiving, by the teleconference computing system, information indicative of a device location from each of the plurality of participant computing devices of the participant cohort and the one or more participant computing devices different than the plurality of participant computing devices of the participant cohort;
making, by the teleconference computing system, a determination that each of the participant computing devices of the participant cohort are co-located; and
forming, by the teleconference computing system, the participant cohort based on the determination.

17. The computer-implemented method of claim 16, wherein forming the participant cohort comprises providing information indicative of assignment to the participant cohort to each of the plurality of participant computing devices of the participant cohort.

18. A teleconference computing system, comprising:
one or more processors;
one or more non-transitory computer-readable media that store instructions that, when executed by the one or more processors, cause the teleconference computing system to perform operations, the operations, comprising:
receiving two or more audio streams from two or more respective participant computing devices of a participant cohort, wherein the participant cohort comprises a plurality of participant computing devices that are each located in a same area and are each connected to a teleconference orchestrated by the teleconference computing system;
obtaining signal quality information indicative of a signal quality associated with each of the two or more audio streams;
updating a signal histogram indicative of a historical signal quality for audios streams received from the plurality of participant computing devices of the participant cohort, wherein the signal histogram is further indicative of a quantity of audio streams from the two or more respective participant computing devices previously selected for broadcast during the teleconference;
selecting a first audio stream from the two or more audio streams for broadcast based at least in part on the signal histogram, wherein selecting the first audio stream comprises:
determining, based on the signal histogram, that the first audio stream has not been previously selected for broadcast within a certain period of time; and
causing broadcast of the first audio stream to one or more participant computing devices different than the plurality of participant computing devices of the participant cohort.

19. The teleconference computing system of claim 18, wherein the two or more audio streams comprise two or more sets of audio packets.

20. One or more non-transitory computer-readable media that store instructions that, when executed by one or more processors, cause the one or more processors to perform operations, the operations comprising:
receiving two or more audio streams from two or more respective participant computing devices of a participant cohort, wherein the participant cohort comprises a plurality of participant computing devices that are each located in a same area and are each connected to a teleconference orchestrated by a teleconference computing system;
obtaining signal quality information indicative of a signal quality associated with each of the two or more audio streams;
updating a signal histogram based on the signal quality information, wherein the signal histogram is indicative of a historical signal quality for audio streams received from the plurality of participant computing devices of the participant cohort, and wherein the signal histogram is further indicative of a quantity of audio streams from the two or more respective participant computing devices previously selected for broadcast during the teleconference;
selecting a first audio stream from the two or more audio streams for broadcast based at least in part on the signal histogram, wherein selecting the first audio stream comprises:
determining, based on the signal histogram, that the first audio stream has not been previously selected for broadcast within a certain period of time; and
causing broadcast of the first audio stream to one or more participant computing devices different than the plurality of participant computing devices of the participant cohort.
